(19) United States
(12) Patent Application Publication
(10) Pub. No.: US 2025/0297392 A1
(43) Pub. Date: Sep. 25, 2025

(54) WATER ELECTROLYSIS STACK

(71) Applicant: HONDA MOTOR CO., LTD., TOKYO (JP)

(72) Inventor: Kazunori FUKUMA, WAKO-SHI (JP)

(21) Appl. No.: 19/052,729

(22) Filed: Feb. 13, 2025

(30) Foreign Application Priority Data
Mar. 22, 2024 (JP) 2024-046849

(51) Int. Cl. C25B 15/08; C25B 9/23; C25B 9/77

(52) U.S. Cl. CPC C25B 15/08; C25B 9/23; C25B 9/77

(57) ABSTRACT

A water electrolysis stack includes: a membrane electrode assembly including an electrolyte membrane and a plate-shaped current collector provided on one of both sides of the electrolyte membrane in the thickness direction thereof; a water introduction unit for introducing water from the outside; a water flow path member disposed so as to face the current collector and provided with a water flow path for guiding, along the surface direction of the current collector, the water introduced into the water introduction unit; and a pumping unit for pumping the water to the water introduction unit. The pumping unit continuously changes the pumping amount of the water, thereby pulsating the water flowing through the water flow path along the surface direction of the current collector.

### CROSS-REFERENCE TO RELATED APPLICATIONS

This application is based upon and claims the benefit of priority from Japanese Patent Application No. 2024-046849 filed on Mar. 22, 2024, the contents of which are incorporated herein by reference.

### BACKGROUND OF THE INVENTION

### Field of the Invention

The present disclosure relates to a water electrolysis stack.

### Description of the Related Art

JP 2012-001745 A discloses a technique for preventing a decrease in electrolysis efficiency due to adhesion of air bubbles generated by electrolysis to the surface of an electrode (current collector). Specifically, a gas-liquid mixture of an electrolytic solution and air bubbles is introduced into an electrolytic cell, and the air bubbles in the introduced gas-liquid mixture are caused to collide with gas (air bubbles) generated on the surface of the electrode (current collector) in the electrolytic cell.

Further, JP 2012-001745 A discloses a method for adjusting air bubbles in the gas-liquid mixture introduced into the electrolytic cell. Specifically, the flow rate of the gas-liquid mixture introduced into the electrolytic cell is adjusted. Further, the diameter of the air bubbles in the gas-liquid mixture introduced into the electrolytic cell is adjusted by the internal pressure of the electrolytic cell. Furthermore, the ratio of air bubbles in the gas-liquid mixture introduced into the electrolytic cell is adjusted by the amount of air bubbles supplied to the electrolytic solution.

### SUMMARY OF THE INVENTION

If the air bubbles stay in the water electrolysis stack, the electrolysis efficiency tends to decrease. Therefore, it is desired to separate the gas generated as air bubbles on the surface of the current collector without positively mixing air bubbles with water introduced into the water electrolysis stack.

The present invention has the object of solving the aforementioned problem.

A first aspect of the present disclosure is a water electrolysis stack comprising: a membrane electrode assembly including an electrolyte membrane and a current collector having a plate shape and provided on one of both sides of the electrolyte membrane in a thickness direction of the electrolyte membrane; a water introduction unit configured to introduce water supplied from an outside; a water flow path member that is disposed so as to face the current collector and is provided with a water flow path configured to guide, along a surface direction of the current collector, the water introduced into the water introduction unit; and a pumping unit configured to pump the water to the water introduction unit, wherein the pumping unit continuously changes a pumping amount of the water, thereby pulsating the water flowing through the water flow path along the surface direction of the current collector.

A second aspect of the present disclosure is a water electrolysis stack comprising: a membrane electrode assembly including an electrolyte membrane and a current collector having a plate shape and provided on one of both sides of the electrolyte membrane in a thickness direction of the electrolyte membrane; a water introduction unit configured to introduce water supplied from an outside; a water flow path member that is disposed so as to face the current collector and is provided with a water flow path configured to guide, along a surface direction of the current collector, the water introduced into the water introduction unit; and a water amount adjustment unit provided in the water introduction unit and configured to adjust an amount of the water introduced into the water introduction unit, wherein the water amount adjustment unit continuously changes the amount of the water, thereby pulsating the water flowing through the water flow path along the surface direction of the current collector.

According to the aspects of the present disclosure, the gas generated as air bubbles on the surface of the current collector due to the electrolysis can be separated from the current collector by the pulsation of water.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram showing a water electrolysis system according to a first embodiment;

FIG. 2 is an exploded perspective view of a water electrolysis cell;

FIG. 3 is a cross-sectional view taken along line III-III of FIG. 2; and

FIG. 4 is a diagram showing the water electrolysis system according to a second embodiment.

### DETAILED DESCRIPTION OF THE INVENTION

### First Embodiment

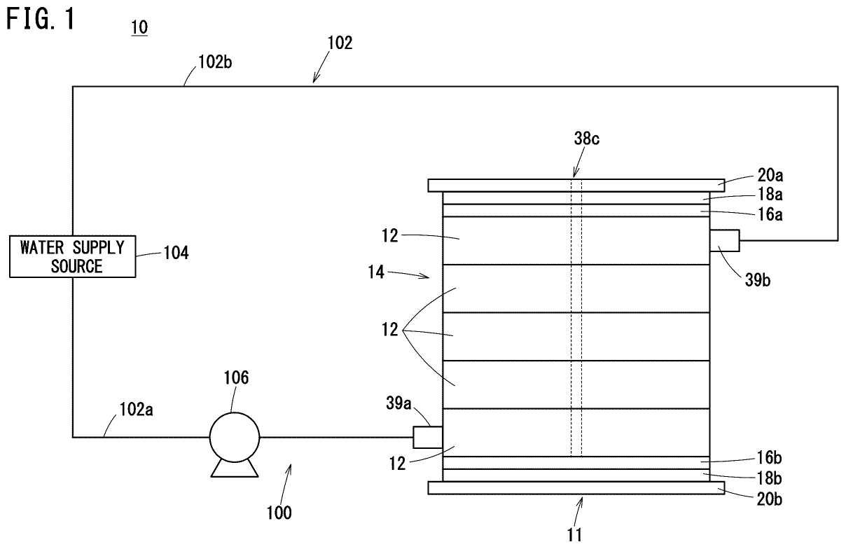

FIG. 1 is a diagram showing a water electrolysis system 10 according to a first embodiment. The water electrolysis system 10 includes a water electrolysis stack 100, a water circulation flow path 102, and a water supply source 104.

The water electrolysis stack 100 includes a stack main body 11. The stack main body 11 includes a plurality of water electrolysis cells 12, a pair of terminal plates 16a and 16b, a pair of insulating plates 18a and 18b, a pair of end plates 20a and 20b, a water introduction unit 39a, and a water lead-out unit 39b. The plurality of water electrolysis cells 12 are stacked. The stacking direction of the water electrolysis cells 12 is the gravity direction, but is not limited thereto. The water electrolysis cells 12 will be described in detail later.

The terminal plate 16a, the insulating plate 18a, and the end plate 20a are arranged in this order upward at one end side (upper end side) of a stacked body 14 in the stacking direction. The terminal plate 16b, the insulating plate 18b, and the end plate 20b are arranged in this order downward at the other end side (lower end side) of the stacked body 14 in the stacking direction. The end plates 20a and 20b are fastened by a pressing mechanism such as a plurality of tie rods extending in the stacking direction of the water electrolysis cells 12. The stack main body 11 is held in a state of being fastened in the stacking direction.

The stack main body 11 is provided with a high-pressure gas discharge hole 38c. The high-pressure gas discharge hole 38c penetrates the plurality of water electrolysis cells 12, the terminal plate 16a, the insulating plate 18a, and the end plate 20a. A pipe (not shown) is connected to the high-pressure gas discharge hole 38c of the end plate 20a. The pipe (not shown) is provided with a back pressure mechanism capable of regulating the discharge of gas.

The water introduction unit 39a is provided in the water electrolysis cell 12 located at one end (lower end) in the stacking direction among the plurality of water electrolysis cells 12. The water introduction unit 39a is configured to introduce water that is supplied from the outside of the stack main body 11. The water lead-out unit 39b is provided in the water electrolysis cell 12 located at the other end (upper end) in the stacking direction among the plurality of water electrolysis cells 12. The water lead-out unit 39b is configured to lead water out to the outside of the stack main body 11.

The water circulation flow path 102 is a channel for allowing water to flow through the stack main body 11. The water circulation flow path 102 is connected to the stack main body 11. The water circulation flow path 102 includes a first flow path portion 102a and a second flow path portion 102b. The first flow path portion 102a connects the water introduction unit 39a and the water supply source 104. The second flow path portion 102b connects the water lead-out unit 39b and the water supply source 104.

The water supply source 104 is a supply source of water to be supplied to the stack main body 11. The water supply source 104 may be a gas-liquid separator that separates water and gas in the water. Alternatively, the water supply source 104 may be a tank that stores water.

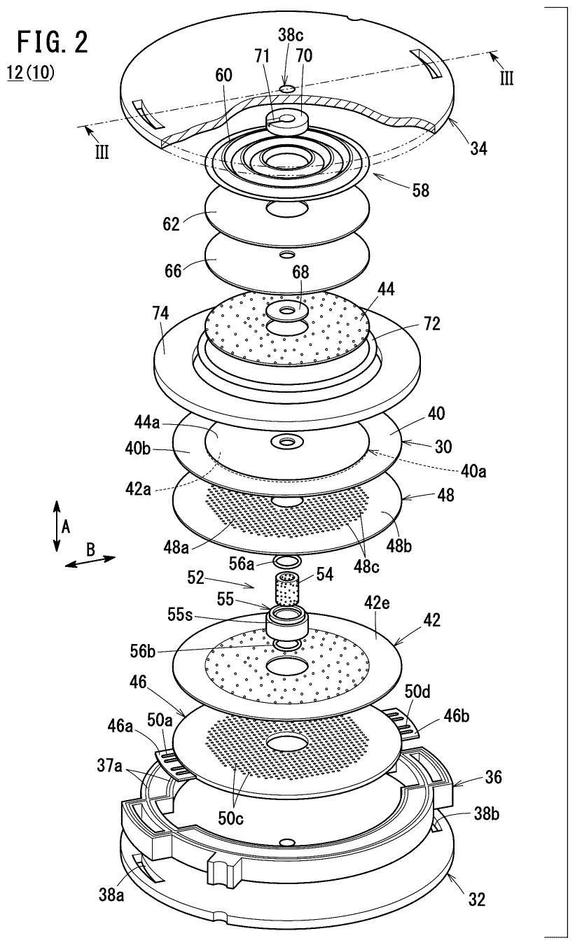

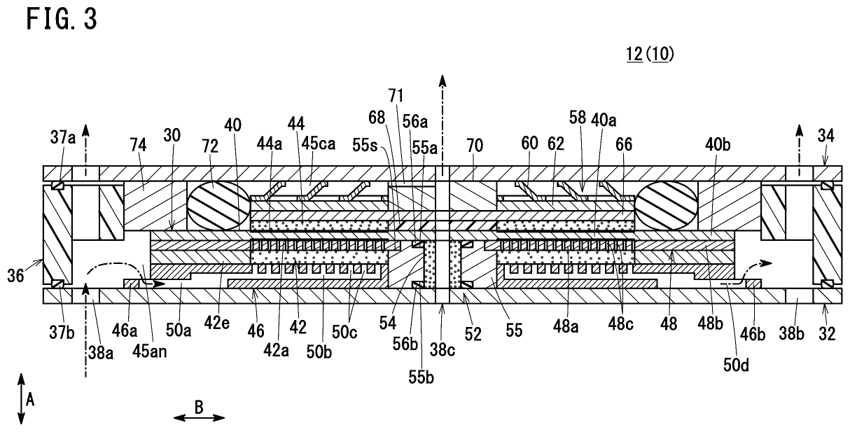

FIG. 2 is an exploded perspective view of the water electrolysis cell 12. FIG. 3 is a cross-sectional view taken along line III-III of FIG. 2. As shown in FIGS. 2 and 3, the water electrolysis cell 12 includes a substantially disc-shaped membrane electrode assembly 30, and a first separator 32 and a second separator 34 that sandwich the membrane electrode assembly 30 and the like therebetween. A frame member 36 is disposed between the first separator 32 and the second separator 34 so as to surround the membrane electrode assembly 30 and the like.

The frame member 36 has a substantially ring shape, and seal members 37a and 37b (see FIG. 3) are provided on both surfaces of the frame member 36, respectively. One end of the frame member 36 in the radial direction thereof (an arrow B direction) is provided with a water inlet 38a extending in the stacking direction (an arrow A direction). The water inlets 38a of the plurality of stacked water electrolysis cells 12 communicate with each other. The water inlets 38a are connected to the water introduction unit 39a.

The other end of the frame member 36 in the radial direction thereof (the arrow B direction) is provided with a water outlet 38b extending in the stacking direction (the arrow A direction). The water outlet 38b is formed to discharge a mixed fluid containing unreacted water that has not been electrolyzed. The water outlets 38b of the plurality of stacked water electrolysis cells 12 communicate with each other. The water outlets 38b are connected to the water lead-out unit 39b.

The water electrolysis cell 12 is provided with the high-pressure gas discharge hole 38c penetrating the radial central portion of the water electrolysis cell 12 in the stacking direction. The high-pressure gas discharge holes 38c of the plurality of stacked water electrolysis cells 12 communicate with each other. The high-pressure gas discharge hole 38c of the water electrolysis cell 12 located at the other end (upper end) in the stacking direction among the plurality of water electrolysis cells 12 communicates with the high-pressure gas discharge hole 38c of the terminal plate 16a (FIG. 1). The gas flowing to the high-pressure gas discharge hole 38c is discharged in a state of being pressurized to, for example, 1 MPa to 80 MPa.

The membrane electrode assembly 30 is formed of an electrolyte membrane 40, a first electrode catalyst layer 42a, a second electrode catalyst layer 44a, a first current collector 42, and a second current collector 44. The first electrode catalyst layer 42a and the first current collector 42 are provided on one of both sides of the electrolyte membrane 40. The second electrode catalyst layer 44a and the second current collector 44 are provided on the other of the both sides of the electrolyte membrane 40.

The first electrode catalyst layer 42a may be simply referred to as the electrode catalyst layer 42a. The same applies to the second electrode catalyst layer 44a. The first current collector 42 may be simply referred to as the current collector 42. The same applies to the second current collector 44.

The electrolyte membrane 40 may be an anion exchange membrane or a proton exchange membrane. In a case where the electrolyte membrane 40 is an anion exchange membrane, water used for electrolysis is alkaline water. In a case where the electrolyte membrane 40 is an anion exchange membrane, the electrode catalyst layer 42a and the current collector 42 function as the anode, and the electrode catalyst layer 44a and the current collector 44 function as the cathode, the gas flowing to the high-pressure gas discharge hole 38c is hydrogen generated by water electrolysis. In this case, the mixed fluid discharged from the water lead-out unit 39b (see FIG. 1) contains unreacted water that has not been electrolyzed and oxygen that is generated by the electrolysis. On the other hand, in a case where the electrolyte membrane 40 is an anion exchange membrane, the electrode catalyst layer 42a and the current collector 42 function as the cathode, and the electrode catalyst layer 44a and the current collector 44 function as the anode, the gas flowing to the high-pressure gas discharge hole 38c is oxygen that is generated by electrolysis. In this case, the mixed fluid discharged from the water lead-out unit 39b (see FIG. 1) contains unreacted water that has not been electrolyzed and hydrogen that is generated by the electrolysis.

In a case where the electrolyte membrane 40 is a proton exchange membrane, water used for electrolysis is water containing impurities (ions) in a predetermined amount or less (for example, pure water). In a case where the electrolyte membrane 40 is a proton exchange membrane, the electrode catalyst layer 42a and the current collector 42 function as the anode, and the electrode catalyst layer 44a and the current collector 44 function as the cathode, the gas flowing to the high-pressure gas discharge hole 38c is hydrogen generated by electrolysis. In this case, the mixed fluid discharged from the water lead-out unit 39b (see FIG. 1) contains unreacted water that has not been electrolyzed and oxygen that is generated by the electrolysis. On the other hand, in a case where the electrolyte membrane 40 is a proton exchange membrane, the electrode catalyst layer 42a and the current collector 42 function as the cathode, and the electrode catalyst layer 44a and the current collector 44 function as the anode, the gas flowing to the high-pressure gas discharge hole 38c is oxygen that is generated by electrolysis. In this case, the mixed fluid discharged from the water lead-out unit 39b (see FIG. 1) contains unreacted water that has not been electrolyzed and hydrogen that is generated by the electrolysis.

The first electrode catalyst layer 42a is provided on a part of one surface of the electrolyte membrane 40. The second electrode catalyst layer 44a is provided on a part of the other surface of the electrolyte membrane 40. The first electrode catalyst layer 42a and the second electrode catalyst layer 44a are formed in, for example, a ring shape.

The electrolyte membrane 40 includes a covered portion 40a covered with the pair of electrode catalyst layers 42a and 44a, and an exposed portion 40b exposed from the electrode catalyst layers. In the water electrolysis cell 12, a range corresponding to the covered portion 40a in the stacking direction is an electrolysis region.

The inner diameter and the outer diameter of the first current collector 42 and the second current collector 44 are set so as to be provided within the electrolysis region. Therefore, the radially inner end portions of the first current collector 42 and the second current collector 44 are arranged at intervals from the high-pressure gas discharge hole 38c in the radial direction.

A frame 42e is fitted to the outer circumference of the first current collector 42. The frame 42e is configured to be denser than the first current collector 42. The frame 42e can be formed by extending the outer circumferential portion of the first current collector 42 outward from the electrolysis region in the radial direction and making the extending portion dense.

The first separator 32, the frame member 36, and the electrolyte membrane 40 define a first chamber 45an (see FIG. 3) in which the first current collector 42 is accommodated. The second separator 34, the frame member 36, and the electrolyte membrane 40 define a second chamber 45ca (see FIG. 3) in which the second current collector 44 is accommodated.

A water flow path member 46 is interposed between the first separator 32 and the first current collector 42 (in the first chamber 45an), and a protective sheet member 48 is interposed between the first current collector 42 and the first electrode catalyst layer 42a. The water flow path member 46 is disposed to face the first current collector 42. An inlet protrusion 46a and an outlet protrusion 46b, which face each other in the radial direction, are formed on the outer circumferential portion of the water flow path member 46.

As shown in FIG. 3, a supply connection passage 50a, which communicates with the water inlet 38a, is formed in the inlet protrusion 46a, and the supply connection passage 50a communicates with a water flow path 50b. The water flow path 50b is a flow path formed in the water flow path member 46 and extends along the surface direction of the first current collector 42. The water flow path 50b guides water in a direction (horizontal direction) lying along the surface of the first current collector 42. A plurality of holes 50c are in communication with the water flow path 50b, and the holes 50c open toward the first current collector 42. A discharge connection passage 50d, which communicates with the water flow path 50b, is formed in the outlet protrusion 46b, and the discharge connection passage 50d communicates with the water outlet 38b.

As shown in FIGS. 2 and 3, the protective sheet member 48 has an inner circumference that is arranged inward of the inner circumference of the first current collector 42, and an outer circumference that is arranged at the same position as the outer circumferences of the electrolyte membrane 40 and the frame 42e. The protective sheet member 48 is formed of a central portion 48a and a frame portion 48b. The central portion 48a is surrounded by the frame portion 48b. The central portion 48a faces the covered portion 40a. The central portion 48a is disposed in the range of the electrolysis region. The outer edge of the electrolysis region and the outer edge of the central portion 48a coincide with each other, but are not limited thereto. A plurality of communication holes 48c are formed in the central portion 48a. The frame portion 48b is located radially outward of the central portion 48a. Rectangular holes (not shown), for example, are formed in the frame portion 48b.

A substantially cylindrical communication hole body 52 surrounding the high-pressure gas discharge hole 38c is disposed between the central portions of the first separator 32 and the electrolyte membrane 40 in the radial direction. Hereinafter, the water flow path member 46, the first current collector 42, and the protective sheet member 48 may be collectively referred to as a water supply side member. In this case, the communication hole body 52 is disposed between the high-pressure gas discharge hole 38c and the water supply side member in the radial direction of the high-pressure gas discharge hole 38c.

The communication hole body 52 includes an inner pipe member 54 made of a porous body and facing the high-pressure gas discharge hole 38c, and an outer pipe member 55 arranged between the inner pipe member 54 and the water supply side member. As shown in FIG. 3, accommodating chambers 55a and 55b are provided on the side of the outer pipe member 55 that faces the inner pipe member 54. The accommodating chambers 55a and 55b are formed by cutting out the radially inner side of the outer pipe member 55 into ring shapes at both ends thereof in the axial direction (stacking direction), and seal members (O-rings) 56a and 56b surrounding the high-pressure gas discharge hole 38c are arranged in the accommodating chambers 55a and 55b. As a result, the high-pressure gas discharge hole 38c is sealed from the first chamber 45an (on the first current collector 42 side).

As shown in FIGS. 2 and 3, on the side of the outer pipe member 55 that faces the water supply side member, a groove 55s on which the protective sheet member 48 is disposed is formed in the end surface of the outer pipe member 55 that faces the electrolyte membrane 40.

The second current collector 44 and a load applying mechanism 58 that presses the second current collector 44 against the second electrode catalyst layer 44a are disposed in the electrolysis region in the second chamber 45ca. The load applying mechanism 58 includes, for example, a conductive elastic member such as a plate spring 60, and the plate spring 60 applies a load to the second current collector 44 via a metal plate spring holder (shim member) 62. As the elastic member, in addition to the plate spring 60, a disc spring, a coil spring, or the like may be used.

On the radially inner side of the electrolysis region in the second chamber 45ca, for example, a resin sheet 68 is disposed as an insulating member that covers the exposed portion 40b of the electrolyte membrane 40. The resin sheet 68 has a thickness that is set to be substantially the same as the thickness of the second current collector 44, and has a ring shape with the high-pressure gas discharge hole 38c formed substantially at the center in the radial direction.

The surfaces of the second current collector 44 and the resin sheet 68 on the plate spring holder 62 side are covered with a conductive sheet 66. The conductive sheet 66 has, for example, a ring shape with the high-pressure gas discharge hole 38c formed substantially at the center in the radial direction.

A tubular member 70 is disposed between the load applying mechanism 58 and the high-pressure gas discharge hole 38c in the radial direction and between the conductive sheet 66 and the second separator 34 in the stacking direction. The tubular member 70 has a cylindrical shape and is made of a conductive material such as metal, and the high-pressure gas discharge hole 38c is formed in the central portion of the tubular member 70. A discharge channel 71, which allows communication between the second chamber 45ca and the high-pressure gas discharge hole 38c, is formed in one end surface of the tubular member 70 that faces the second separator 34.

As described above, by arranging the communication hole body 52 (the outer pipe member 55) and the tubular member 70 between the first separator 32 and the second separator 34, the load bearing capacity can be improved in the vicinity of the high-pressure gas discharge hole 38c of the water electrolysis cell 12. Further, the electrolyte membrane 40, the resin sheet 68, and a portion of the conductive sheet 66 on the radially inner side of the electrolysis region (a portion in the vicinity of the high-pressure gas discharge hole 38c) are sandwiched between the communication hole body 52 and the tubular member 70.

A seal member (O-ring) 72 is disposed on the radially outer side of the electrolysis region in the second chamber 45ca so as to be interposed between the electrolyte membrane 40 and the second separator 34. A pressure resistant member 74 is disposed on the outer circumference of the seal member 72. The pressure resistant member 74 has a substantially ring shape, and the outer circumferential portion thereof is fitted into the inner circumferential portion of the frame member 36.

In the water electrolysis cell 12, a conductive passage electrically connected from the second separator 34 to the tubular member 70, the conductive sheet 66, and the second current collector 44, and a conductive passage electrically connected from the second separator 34 to the plate spring 60, the plate spring holder 62, the conductive sheet 66, and the second current collector 44 are formed.

The stack main body 11 is provided with the water electrolysis cells 12 basically configured as described above.

As shown in FIG. 1, the water electrolysis stack 100 further includes a pumping unit 106 in addition to the stack main body 11.

The pumping unit 106 is provided separately from the stack main body 11. Specifically, the pumping unit 106 is provided in the first flow path portion 102a. The pumping unit 106 pumps water to the water introduction unit 39a. The pumping unit 106 may be a pump. The type of the pump is not particularly limited. The type of the pump includes a centrifugal pump, a turbine pump, a cascade pump, a piston pump, a plunger pump, a diaphragm pump, a wing pump, an injection pump, and the like.

The pumping unit 106 continuously changes the pumping amount of water. For example, the pumping unit 106 periodically changes the pumping amount between a first pumping amount and a second pumping amount larger than the first pumping amount. As a result, pulsation occurs in the water flowing inside the stack main body 11. In other words, the pressure and the flow rate of the water flowing inside the stack main body 11 periodically fluctuate. As shown in FIG. 3, the pulsation reaches the water flow path 50b through the water inlet 38a and the supply connection passage 50a in this order. The pulsation that has reached the water flow path 50b propagates in a direction (horizontal direction) lying along the surface of the first current collector 42, and reaches the water outlet 38b through the discharge connection passage 50d. The pulsation that has reached the water outlet 38b is supplied from the water lead-out unit 39b to the second flow path portion 102b of the water circulation flow path 102, as shown in FIG. 1.

In this manner, in the present embodiment, the pumping unit 106 continuously changes the pumping amount of water, thereby pulsating the water flowing through the water flow path 50b along the surface direction of the current collector (the first current collector) 42. As a result, the gas generated as air bubbles on the surface of the current collector (the first current collector) 42 due to the electrolysis can be separated from the current collector by the pulsation of the water.

### Second Embodiment

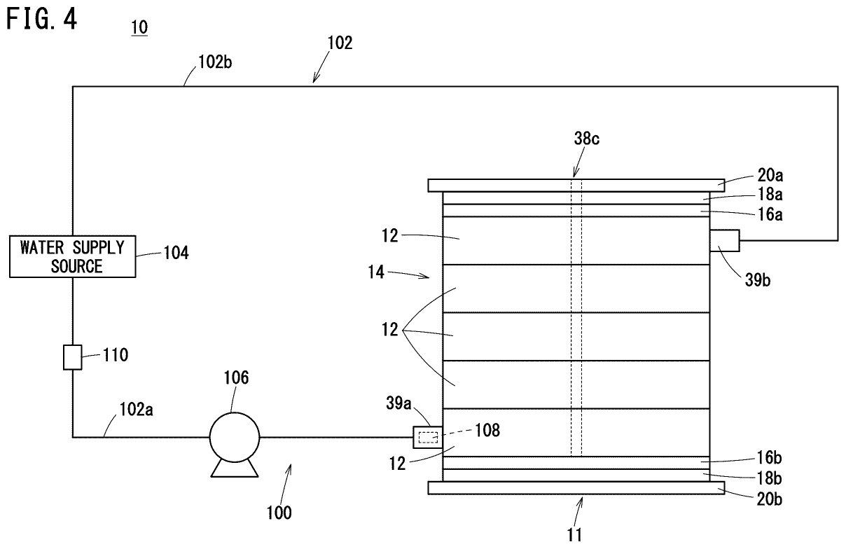

In the present embodiment, the description overlapping with that of the first embodiment will be omitted. FIG. 4 is a diagram showing the water electrolysis system 10 according to the second embodiment. In FIG. 4, the same components as those described in the first embodiment are denoted by the same reference numerals.

In the present embodiment, the pumping unit 106 operates at a rated output. The amount of water that is pumped from the pumping unit 106 to the water introduction unit 39a per unit time is substantially constant.

Further, in the present embodiment, the water electrolysis system 10 further includes a water amount adjustment unit 108. In FIG. 4, the water amount adjustment unit 108 is provided in the water introduction unit 39a, but the present invention is not limited thereto. For example, the water amount adjustment unit 108 may be provided between the pumping unit 106 and the stack main body 11 in the first flow path portion 102a. The water amount adjustment unit 108 adjusts the amount of water introduced into the water introduction unit 39a. The water amount adjustment unit 108 may be a valve element (valve device). The valve element is not particularly limited as long as the flow rate thereof can be adjusted. Examples of such a valve element include a butterfly valve, a gate valve, a globe valve, a ball valve, and the like. The water amount adjustment unit 108 continuously changes the amount of water introduced into the water introduction unit 39a. As a result, pulsation occurs in the water flowing inside the stack main body 11. As described with reference to FIG. 3, the pulsation that has reached the water flow path 50b propagates in a direction (horizontal direction) lying along the surface of the first current collector 42, and reaches the water outlet 38b through the discharge connection passage 50d.

In this manner, in the present embodiment, the water amount adjustment unit 108 continuously changes the amount of water introduced into the water introduction unit 39a, thereby pulsating the water flowing through the water flow path 50b along the surface direction of the current collector (the first current collector) 42. As a result, the gas generated as air bubbles on the surface of the current collector (the first current collector) 42 due to the electrolysis can be separated from the current collector by the pulsation of the water.

Further, in the present embodiment, water is supplied to the water amount adjustment unit 108 from the pumping unit 106 that operates at a rated output. This allows the water to pulsate regularly.

It should be noted that, in the present embodiment, the pumping unit 106 may change the pumping amount of water at a predetermined cycle. In this case, the water amount adjustment unit 108 can make the pulsation of the water finer by changing, at a cycle shorter than the cycle of the pumping unit 106, the amount of water introduced into the water introduction unit 39a. Alternatively, the water amount adjustment unit 108 can irregularly pulsate the water by changing, at a random cycle different from the cycle of the pumping unit 106, the amount of water introduced into the water introduction unit 39a.

Further, in the present embodiment, the water electrolysis system 10 further includes a pressurizing unit 110 that pressurizes water introduced into the water introduction unit 39a. The pressurizing unit 110 applies pressure to the water flowing through the first flow path portion 102a. This can increase the degree of change in the pressure and flow rate of the water flowing inside the stack main body 11. In FIG. 4, the pressurizing unit 110 is provided in a portion of the first flow path portion 102a located between the water supply source 104 and the pumping unit 106, but may be provided in a portion of the first flow path portion 102a located between the stack main body 11 and the pumping unit 106. Further, in the present embodiment, one of the pumping unit 106 or the pressurizing unit 110 may not be provided. The pressurizing unit 110 may be provided in the first flow path portion 102a of the first embodiment.

The following supplementary notes are further disclosed in relation to the above-described embodiments.

### Supplementary Note 1

The water electrolysis stack (100) of the present disclosure includes: the membrane electrode assembly (30) including the electrolyte membrane (40) and the current collector (42) having a plate shape and provided on one of both sides of the electrolyte membrane in the thickness direction thereof; the water introduction unit (39a) configured to introduce water supplied from an outside; the water flow path member (46) that is disposed so as to face the current collector and is provided with the water flow path (50b) configured to guide, along the surface direction of the current collector, the water introduced into the water introduction unit; and the pumping unit (106) configured to pump the water to the water introduction unit, wherein the pumping unit continuously changes the pumping amount of the water, thereby pulsating the water flowing through the water flow path along the surface direction of the current collector.

### Supplementary Note 2

The water electrolysis stack of the present disclosure includes: the membrane electrode assembly including the electrolyte membrane and the current collector having a plate shape and provided on one of both sides of the electrolyte membrane in the thickness direction thereof; the water introduction unit configured to introduce water supplied from an outside; the water flow path member that is disposed so as to face the current collector and is provided with the water flow path configured to guide, along the surface direction of the current collector, the water introduced into the water introduction unit; and the water amount adjustment unit (108) provided in the water introduction unit and configured to adjust an amount of the water introduced into the water introduction unit, wherein the water amount adjustment unit continuously changes the amount of the water, thereby pulsating the water flowing through the water flow path along the surface direction of the current collector.

### Supplementary Note 3

In the water electrolysis stack according to Supplementary Note 1 or 2, the electrolyte membrane, the current collector, and the water flow path member may be stacked in a gravity direction, and the water flow path may extend in a horizontal direction.

### Supplementary Note 4

In the water electrolysis stack according to Supplementary Note 2, the water may be supplied to the water amount adjustment unit from the pumping unit configured to operate at a rated output.

### Supplementary Note 5

The water electrolysis stack according to Supplementary Note 1 or 2 may further include the pressurizing unit (110) configured to pressurize the water introduced into the water introduction unit.

Although the present disclosure has been described in detail, the present disclosure is not limited to the above-described individual embodiments. Various additions, replacements, modifications, partial deletions, and the like can be made to these embodiments without departing from the gist of the present disclosure, or without departing from the essence of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A water electrolysis stack comprising:
a membrane electrode assembly including an electrolyte membrane and a current collector having a plate shape and provided on one of both sides of the electrolyte membrane in a thickness direction of the electrolyte membrane;
a water introduction unit configured to introduce water supplied from an outside;
a water flow path member that is disposed so as to face the current collector and is provided with a water flow path configured to guide, along a surface direction of the current collector, the water introduced into the water introduction unit; and
a pumping unit configured to pump the water to the water introduction unit,
wherein the pumping unit continuously changes a pumping amount of the water, thereby pulsating the water flowing through the water flow path along the surface direction of the current collector.

2. The water electrolysis stack according to claim 1, wherein
the electrolyte membrane, the current collector, and the water flow path member are stacked in a gravity direction, and
the water flow path extends in a horizontal direction.

3. The water electrolysis stack according to claim 1, further comprising a pressurizing unit configured to pressurize the water introduced into the water introduction unit.

4. A water electrolysis stack comprising:
a membrane electrode assembly including an electrolyte membrane and a current collector having a plate shape and provided on one of both sides of the electrolyte membrane in a thickness direction of the electrolyte membrane;
a water introduction unit configured to introduce water supplied from an outside;
a water flow path member that is disposed so as to face the current collector and is provided with a water flow path configured to guide, along a surface direction of the current collector, the water introduced into the water introduction unit; and
a water amount adjustment unit provided in the water introduction unit and configured to adjust an amount of the water introduced into the water introduction unit,
wherein the water amount adjustment unit continuously changes the amount of the water, thereby pulsating the water flowing through the water flow path along the surface direction of the current collector.

5. The water electrolysis stack according to claim 4, wherein
the electrolyte membrane, the current collector, and the water flow path member are stacked in a gravity direction, and
the water flow path extends in a horizontal direction.

6. The water electrolysis stack according to claim 4, wherein
the water is supplied to the water amount adjustment unit from a pumping unit configured to operate at a rated output.

7. The water electrolysis stack according to claim 4, further comprising a pressurizing unit configured to pressurize the water introduced into the water introduction unit.
